(19) United States
(12) Patent Application Publication
(10) Pub. No.: US 2019/0036215 A1
(43) Pub. Date: Jan. 31, 2019

(54) SYSTEM AND METHOD FOR BEAMFORMING USING A PHASED ARRAY ANTENNA

(71) Applicant: HUAWEI TECHNOLOGIES CO., LTD., Shenzhen (CN)

(72) Inventors: Hoda Shahmohammadian, Ottawa (CA); Shaul Klein, Kanata (CA)

(21) Appl. No.: 15/659,230

(22) Filed: Jul. 25, 2017

(51) Int. Cl. H01Q 3/38; H01Q 21/22; H01Q 21/00

(52) U.S. Cl. CPC H01Q 3/38; H01Q 1/247; H01Q 21/0025; H01Q 21/22

(57) ABSTRACT

A technique includes communicating orthogonal signals with an antenna array. The antenna array includes a plurality of pairs of antenna elements. The technique includes amplifying the orthogonal signals and controlling the amplification of the orthogonal signals to regulate a directivity of a beam pattern of the antenna array.

### BACKGROUND

Wireless stations may benefit from wireless communications in the unlicensed 60 GigaHertz (GHz) frequency band, as the relatively large spectrum of this band allows for a data transmission rate as large as 7 Gigabits per second (Gbps). Due to the significant attenuation of high frequency wireless signals (e.g., signals in the 60 GHz band) caused by walls and other objects, wireless communications in the 60 GHz frequency band are typically transmitted and received in a highly directional manner. Advantageously, lower-power transceiver hardware may be used for directional communications, as compared to transceiver hardware that is associated with omnidirectional communication.

For directional communications between a pair of wireless stations, a process called “beamforming” may be used to directionally steer the antenna beams of the stations toward each other. In this manner, the beamforming process results in the wireless stations identifying directivities for their antenna beam patterns so that the stations may steer the main lobes of the antenna beam patterns toward each other.

A wireless station may have a phased array antenna, which is formed from a spatially arranged array of antenna elements and a beamforming circuit that combines signals that are communicated with the elements in a way that allows the main lobe of the antenna beam that is associated with the array to be steered in a particular direction. In this manner, the beamforming circuit may include amplifiers and variable phase shifters that are controlled to apply selected gains and phase shifts to the signals to direct the main lobe in a given direction.

### SUMMARY

The beamforming circuit for a phased array antenna may include variable phase shifters, which shift the phases of signals that are communicated with antenna elements of the array to steer an antenna beam in a desired direction. Due to phase and amplitude variations that are introduced by the variable phase shifters, however, it may be challenging for such a beamforming circuit to produce an antenna beam having a sufficiently fine resolution to avoid strong interferers. Moreover, in general, achieving a finer granularity in the beamforming may involve using multiple stages of variable phase shifters, which may introduce temperature instabilities and relatively high power losses. According to aspects of the present disclosure, a phased array antenna has antenna elements that are arranged in sub-arrays in a way that allows a beamforming circuit to control a directivity of the associated antenna beam without using variable phase shifters. In this manner, in accordance with aspects of the present disclosure, each sub-array may include a pair of antenna elements that communicate orthogonal signals, and the amplification of these orthogonal signals may be controlled to set the main lobe angle for the antenna beam, all without using variable phase shifters. Accordingly, in accordance with example implementations, the phased array antenna may be relatively easy to calibrate, may exhibit more stability to temperature fluctuations and may be relatively less complex, as compared to phase array antennas that rely on variable phase shifters.

According to an aspect of the present disclosure, there is provided a technique that includes communicating orthogonal signals with an antenna array. The antenna array includes a plurality of pairs of antenna elements. The technique includes amplifying the orthogonal signals and controlling the amplification of the orthogonal signals to regulate a directivity of a beam pattern of the antenna array.

According to another aspect of the present disclosure, there is provided an apparatus that includes a planar array of antenna elements; a beamforming circuit and a controller. The antenna elements are grouped into a plurality of sub-arrays, and the beamforming circuit includes a plurality of amplifiers. The beamforming circuit, for each sub-array, communicates a first signal with a first antenna element of the sub-array and communicates a second signal with a second antenna element of the sub-array. The first and second signals are orthogonal relative to each other. The controller regulates the gains of the amplifiers to regulate a directivity of a beam pattern that is associated with the array.

According to another aspect of the present disclosure, there is provided an apparatus that includes a radio; a continuous phased array antenna; a beamforming circuit; and a controller. The continuous phased array antenna is coupled to the radio to radiate electromagnetic energy and sense radiated electromagnetic energy. The phased array antenna includes a planar array of antenna elements that are arranged in pairs. Each pair of antenna elements is associated with an amplitude value and a phase value associated with an antenna beam pattern. The beamforming circuit includes, for a given pair of antenna elements of the antenna elements, a first communication path and a second communication path. The first communication path includes a first amplifier, and the first communication path communicates a first signal with a first element of the given pair of antenna elements. The second communication path includes a second amplifier, and the second communication path communicates a second signal with a second element of the given pair of antenna elements. The beamforming circuit includes at least one fixed phase shifter that is disposed in one of the first and second communication paths to cause the first and second signals to be orthogonal to each other. The controller to, for the given pair of antenna elements, set a first gain of the first amplifier and set a second gain of the second amplifier to regulate a directivity of the antenna beam pattern.

Optionally, in any of the preceding aspects, in another implementation, communicating orthogonal signals with the pairs includes communicating a first signal of the orthogonal signals using a first communication path that includes a fixed phase shifter and an amplifier; and communicating a second signal of the orthogonal signals using a second communication path that includes a second amplifier.

Optionally, in any of the preceding aspects, in another implementation, communicating the first signal includes receiving the first signal from a first antenna element of a given pair of antenna elements and providing the first signal to the first communication path. Communicating the second signal includes receiving the second signal from a second antenna element of the given pair of antenna elements and providing the second signal to the second communication path.

Optionally, in any of the preceding aspects, in another implementation, communicating the first signal includes receiving the first signal from the first communication path and providing the first signal to a first antenna element of a given pair of antenna elements. Communicating the second signal include receiving the second signal from the second communication path and providing the second signal to a second antenna element of the given pair of antenna elements.

Optionally, in any of the preceding aspects, in another implementation, communicating the first signal using the first communication path includes setting a gain of the first amplifier based on the cosine of a phase angle. Communicating the second signal using the second communication path includes setting a gain of the second amplifier based on the sine of the phase angle.

Optionally, in any of the preceding aspects, in another implementation, communicating the first signal using the first communication path includes setting a gain of the first amplifier based on the product of an amplitude and cos(θk−ε). Communicating the second signal using the second communication path includes setting a gain of the second amplifier based on the product of the amplitude and sin(θk+ε).

Optionally, in any of the preceding aspects, in another implementation, the antenna elements of the given pair of antenna elements are associated with a spacing | between the elements of the given pair. A main lobe of the beam pattern is associated with an angle θ₀. The first and second signals are associated with a wavelength λ; and ϵ represents π·|·sin(θ₀)/λ.

Optionally, in any of the preceding aspects, in another implementation, adjacent pairs of the pairs of antenna elements are separated by a spacing d; and θₖ represents 2π·(k−1)·d·sin(θ₀)/λ, where θ₀ represents a main lobe of the beam pattern, λ represents a wavelength associated with the first and second signals, and k represents an integer.

Optionally, in any of the preceding aspects, in another implementation, the phase shifter may be a fixed ninety degrees phase shifter.

Optionally, in any of the preceding aspects, in another implementation, the phased array antenna may be a continuous phased array antenna or a digital phased array antenna.

### BRIEF DESCRIPTION OF THE DRAWINGS

FIGS. 1 and 5 are schematic diagrams of wireless stations according to example implementations.

FIG. 2 is a schematic diagram illustrating example reception channels for the phased array antenna of FIG. 1 according to an example implementation.

FIGS. 3, 4 and 6 are flow diagrams depicting techniques to control an antenna beam formed by a phased array antenna according to example implementations.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

A given pair of wireless stations may communicate with each other in a frequency band (the 60 GHz band, for example), which is highly directional. As such, the pair of wireless stations may employ “beamforming,” which refers to a process to determine how the antenna beams of the stations should be directed, or steered, for purposes of communicating data between the wireless stations. In this manner, a wireless station may have one or multiple antennas that may be controlled by the station to control the direction of its antenna beam pattern to steer a main lobe (the main beam) of the antenna gain pattern in a particular direction (along a particular azimuth, for example). In general, beamforming may involve the wireless stations transmitting and receiving electromagnetic energy in a process that determines an optimum antenna beam direction for each wireless station for its subsequent data communications with the other station.

In accordance with example implementations, the wireless station has a phased array antenna, which contains an array of antenna elements. In a transmit mode of operation for the wireless station, the antenna elements are driven by electrical signals to cause the elements to emit electromagnetic radiation, and in a receive mode of operation for the wireless station, the antenna elements provide electrical signals that represent electromagnetic radiation received by the antenna elements.

A beamforming circuit of the phased array antenna combines signals that are communicated with the antenna elements in way to form an antenna beam pattern that has certain characteristics, such as a main lobe of the beam pattern being oriented in a certain direction, the beam pattern having a certain number of side lobes and nulls, the side lobes and nulls being located at certain locations, the beam pattern having a certain envelope characterizing prominence of the side lobes relative to the main lobe, and so forth. In general, the beamforming circuit applies a set of complex values to signals that are communicated with the antenna elements to form a beam pattern, or gain, for the antenna. One way to do this is to route the signals through variable phase shifters and amplifiers. In this manner, the gains of the amplifiers and the phase shifters that are introduced by the variable shifters may be controlled to correspondingly control the application of the complex values to the signals to regulate the antenna beam pattern.

However, unlike conventional arrangements, in accordance with example implementations, a phased array antenna does not employ variable phase shifters. Instead, as described herein, the antenna elements of the phased array antenna are grouped, or arranged, in pairs (i.e., in sub-arrays each having two antenna elements); and the beamforming circuit includes fixed phase shifters to establish the orthogonal signals with the elements of each pair. As described herein, due to this configuration, the antenna beam pattern for the phased array antenna may be guided, or steered, solely by controlling the amplitudes of the signals that are communicated with the antenna elements, all without the use of variable phase shifters. In the context of this application, communicating signals with the antenna elements refers to either providing signals to the antenna elements (for purposes of transmission) or receiving signals from the antenna elements (for purposes of reception).

As further described herein, in accordance with example implementations, amplifiers are coupled in-line with the antenna element signals; and the beamforming circuit controls the amplifications, or gains, that are applied by the amplifiers to steer the antenna beam pattern in a given direction (i.e., to control a directivity of the antenna beam pattern).

In accordance with example implementations that are described herein, the beamforming circuit includes analog amplifiers, and the phased array antenna is a continuous phased array antenna. However, in accordance with further example implementations, the beamforming circuit may include digital power amplifiers, and the phased array antenna may be a digital phased array antenna.

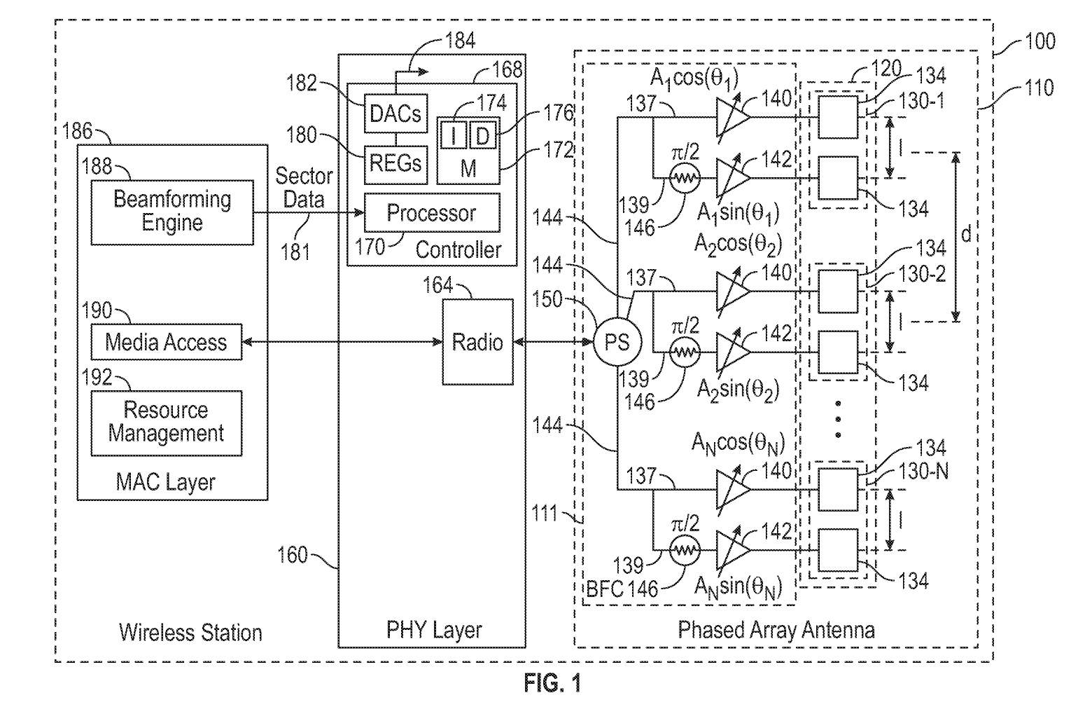

As a more specific example, FIG. 1 depicts a wireless station 100 in accordance with some implementations. As examples, the wireless station 100 may be a mobile wireless communication device, such as a smartphone, a tablet, or a wearable electronic device (a watch, for example); or the wireless station 100 may be a fixed position wireless communication device, such as a wireless access point, or a wireless communication bridge. In general, the wireless station 100 may be any electronic device that communicates by sensing and emitting electromagnetic radiation and for this purpose, employs beamforming (i.e., manipulates signals that are communicated with antenna elements to guide, or steer, an antenna beam pattern in a certain direction).

The wireless station 100 may communicate over any of a number of different frequency bands. For example, in accordance with some implementations, the wireless station 100 may communicate using wireless signaling within a spectrum at or near 60 Gigahertz (GHz). Depending on the particular implementation, the wireless communications by the wireless station 100 may be within a licensed or an unlicensed spectrum. Moreover, as examples, the wireless communications may involve cellular network communications, cellular backhaul communications and non-cellular network communications, such as, for example, wireless communications over the 60 GHz band that comply with the Institute of Electrical and Electronics Engineers (IEEE) 802.11ad specification (also referred to as the WiGig specification).

In accordance with some implementations, the wireless station 100 may be a mobile wireless device, which communicates with other wireless stations using synchronized units of wireless communication called “super frames,” or “beacon intervals.” In this manner, an initial part of the beacon interval may be dedicated to the beamforming process, and a subsequent part of the beacon interval may be dedicated to communicating data using antenna configurations that were determined using the beamforming process. The inclusion of beamforming in each beacon interval accommodates movements of mobile wireless stations. For example, the WiGig specification defines a beamforming protocol for purposes of selecting antenna sectors for an initiator (a wireless access point, for example) and a responder (a mobile wireless station, for example). In this manner, at the conclusion of the beamforming part of the beacon interval, the responder and the initiator have identified the best antenna sectors of the initiator and responder for purposes of communicating data with each other.

In accordance with example implementations, the wireless station 100 includes a phased array antenna 110. In general, the phased array antenna 110 includes an array 120 of antenna elements 134, which, for purposes of transmissions, radiate electromagnetic energy in response to signals being communicated to the elements 134; and for purposes of reception, the antenna elements 134 provide electrical signals representing electromagnetic radiation that is sensed by the elements 134.

FIG. 1 depicts a beamforming circuit 111 that is used to condition signals that are communicated with the antenna elements 134 for purposes of forming transmission and reception antenna beams for the phased array antenna 110. For the specific circuitry of the beamforming circuit 111 that is depicted in FIG. 1, the beamforming circuit 111 forms a transmission antenna beam for the phased array antenna 110. As described herein, the beamforming circuit 111 conditions the signals that are communicated with the antenna elements 134 so that the electromagnetic radiations from the elements 134 constructively and destructively interfere to form the transmission antenna beam pattern.

In accordance with some implementations, the array 120 of antenna elements 134 lies in a plane to define a planar array; and more specifically, as depicted in FIG. 1, the antenna elements 134 of the array 120 may be spatially arranged along a particular line to form a linear antenna array. It is noted that in accordance with further example implementations, the antenna elements 134 may be oriented in two-dimensions within a plane. The beamforming circuit 111 conditions the signals that are communicated with the antenna elements 134, as described herein, to form a transmission antenna beam pattern that has a main lobe, nulls, and side lobes; and the main lobe is oriented at an angle (called the “main lobe angle θ₀” herein) with respect to the line along which the antenna elements 134 are disposed.

In accordance with example implementations, the antenna elements 134 are arranged, or grouped, into N sub-arrays 130 (example antenna sub-arrays 130-1, 130-2 and 130-N, being depicted in FIG. 1), where each sub-array 130 contains a pair of spatially adjacent antenna elements 134. More specifically, in accordance with example implementations, the antenna elements 134 of a given sub-array 130 are spaced apart by an intra sub-array spacing distance (called “l” in FIG. 1), and the antenna element sub-arrays 130 are spaced apart by an inter sub-array spacing distance (called “d” in FIG. 1). In general, as further described herein, in accordance with example implementations, the inter sub-array spacing distance d is much larger than the intra sub-array spacing l distance (l may be equal to or less than one half of d, for example).

In accordance with example implementations, each sub-array 130 is associated with a transmission channel 144 that communicates a transmission signal from a power splitter 150 of the beamforming circuit 111. The transmission channel 144, in turn, is coupled to orthogonal signal communication paths, or transmission channels, which are referred to as “signal channels 137 and 139” herein. The signal channels 137 and 139 communicate orthogonal transmission signals to respective antenna elements 134 of the associated sub-array 130. In this manner, the signal channel 137 is coupled to the transmission channel 144 to communicate a transmission signal to one of the antenna elements 134 of the sub-array 130, which is in-phase with the transmission signal of the transmission channel 144 (i.e., the signals have the same phases); and the other signal channel 139 is coupled to the transmission channel 144 and contains a fixed ninety degree phase shifter 146 to communicate a signal with the other antenna element 134, which is orthogonal relative to the transmission signal of the transmission channel 144 (and relative to the in-phase signal of the channel 137).

As depicted in FIG. 1, in accordance with example implementations, the orthogonal signal channels 137 and 139 do not contain variable phase shifters. As described herein, the gains of power amplifiers 140 (of the signal channel 137) and 142 (of the signal channel 139) are controlled for purposes of controlling the transmission antenna beam pattern (i.e., for purposes of controlling the features of the transmit antenna beam pattern such as the locations of the main lobe, the width of the main lobe, the main lobe angle θ₀ (i.e., the directivity of the antenna beam pattern), the locations and relative gains of side lobes, locations of nulls, relative sizes of side lobes as compared to the main lobe, and so forth). In this manner, in accordance with example implementations, the gains of the amplifiers 140 and 142 are controlled and no variable phase shifters are used for purposes of setting the main lobe angle θ₀ of the transmit antenna beam pattern. Accordingly, the phased array antenna 110 may have advantages when compared the phased array antennas that employ variable phase shifters, such as more stability against temperature variations, less complexity and a lower cost. Moreover, because the features of the antenna beam are set by amplifier gains, the phased array antenna 110 may be relatively easier to calibrate.

In accordance with further example implementations, a fixed phase shifter other than a ninety degree phase shifter may be used to create the orthogonal signals for the orthogonal signal channels 137 and 139. For example, in accordance with further implementations, one of the channels 137 and 139 may include a fixed phase shifter that introduces a phase lag of forty-five degrees, and the other channel 137, 139 may contain a fixed phase shifter that introduces a phase lead of forty-five degrees.

For a conventional phased array antenna having a linear array of antenna elements, each antenna element may be associated with an amplitude value called “Aₖ” herein (wherein “k” is an array element index) and a phase value called “θₖ” herein. In this manner, a narrowband assumption may be made (an assumption that the propagation delay across the array is much smaller than the reciprocal of the signal bandwidth) so that the delays that are applied to the array elements may be represented by the θₖ phase values. For the conventional phased array antenna, a set of Aₖ and θₖ values may be determined to form a given antenna beam pattern; and accordingly, the phase of the signal that is communicated with the kth antenna element of the linear array is shifted by a variable phase shifter by the θₖ phase value, and the signal is amplified by the Aₖ value.

For the phased antenna array 110 of FIG. 1, the sub-arrays 130 are associated with the Aₖ and θₖ values; and the gains of the amplifiers 140 and 142 are functions of the Aₖ and θₖ values. In particular, in accordance with example implementations, when the inter sub-array spacing distance d is much larger than the intra sub-array spacing distance l, the gains of the amplifiers 140 and 142 of the kth sub-array 130 may be described as follows:

Gain_{AMPLIFIER 140}=Aₖ cos(θₖ), and Eq. 1

Gain_{AMPLIFIER 142}=Aₖ sin(θₖ). Eq. 2

Thus, for example, the gains of the amplifier 140 and 142 for the sub-array 130-1 are A₁ cos(θ₁) and A₁ sin(θ₁), respectively.

As a more specific example, in accordance with some implementations, the θₖ phase value may be described as follows:

$${θ}_{k} = \frac{2 π d ( k - 1 ) sin {θ}_{0}}{λ} , \qquad Eq . 3$$

where “λ” represents the signal wavelength, i.e. the wavelength of the signals that are communicated with the antenna elements 134. Moreover, for the case in which the inter sub-array spacing distance d is much greater than the intra sub-array spacing distance l (l≤0.1d, for example), the antenna gain (called “P(θ₀)” herein) may be described as follows, which is the theoretical gain for a conventional phased array antenna having continuous variable phase shifters:

$$P ( {θ}_{0} ) = {‖ {\sum }_{k = 1}^{N} {A}_{k} {e}^{\frac{j2 π d ( k - 1 ) sin ( θ )}{λ} - j {θ}_{k}} ‖}^{2} . \qquad Eq . 4$$

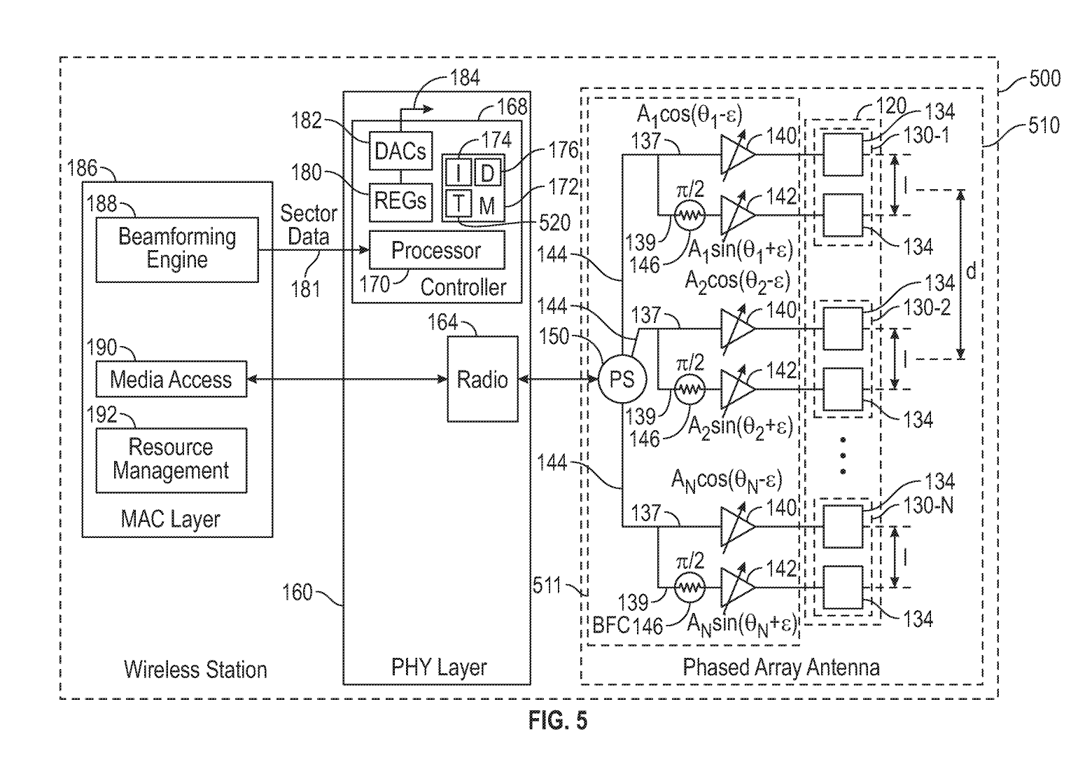

In Eq. 4, “j” denotes an imaginary number; and “N” is an integer that represents the number of sub-arrays 130. As the inter sub-array spacing distance d approaches the intra sub-array spacing distance l, the antenna gain may experience an increasing amount of side lobe energy. However, the gains of the antennas 140 and 142 may be calculated and set using a different methodology, which makes the antenna gain invariant to the intra sub-array spacing distance l, as further described below in connection with FIG. 5.

Referring to FIG. 1, in accordance with example implementations, a controller 168 of a physical layer 160 of the wireless station 100 may take the following actions to control the antenna beam pattern for the phased array antenna 110. In general, the controller 168 may contain one or multiple processors 170 (one or multiple central processing units (CPUs), one or multiple CPU processing cores, and so forth). A beamforming engine 188 (of a media access control (MAC) layer 186 of the wireless station 100, for example) may, in a beamforming part of a given beacon interval, communicate with another wireless station in a beamforming process; and at the conclusion of the beamforming part of the beacon interval, the beamforming engine 188 may provide sector data 181 to the processor 170. The sector data 181 identifies the main lobe angle θ₀ for the antenna beam pattern, and based on the main lobe angle θ₀, the processor(s) 170 determine the gains for the amplifiers 140 and 142 of the beamforming circuit 111.

In this manner, in accordance with example implementations, the processor(s) 170 determine the Aₖ and θₖ values; determine amplifications, or gains to be applied by the amplifiers 140 and 142 for the entire array 120, pursuant to Eqs. 1 and 2 based on the the Aₖ and θₖ values; and write values corresponding to the gains to one or multiple registers 180 of the controller 168. Moreover, in accordance with example implementations, the controller 168 may include one or multiple digital-to-analog converters (DACs) 182, which provide analog outputs 184 representing the gain, or amplification, values for the amplifiers 140 and 142.

In this manner, the outputs 184, in turn, in accordance with example implementations, control the gains of the amplifiers 140 and 142 of the phased array antenna 110. For example, in accordance with some implementations, the outputs 184 may control the biasing of current sources and/or current mirrors of the power amplifiers 140 and 142 to correspondingly control the gains of the amplifiers 140 and 142.

In accordance with some implementations, the controller 168 may include a memory 172, which stores, for example, program instructions 174 that are executed by the processor(s) 170 for performing processor functions, as described herein, as well as data 176 involved in calculating the gains for the amplifiers 140 and 142 for a given main lobe angle θ₀. In general, the memory 172 may be formed from non-transitory memory devices, such as semiconductor devices, memristors, phase change memory devices, volatile memory devices, non-volatile memories, a combination of one or more of these storage technologies, and so forth.

In accordance with further example implementations, the controller 168 may not be processor-based and may instead be formed from one or multiple hardwired circuits, such as one or multiple field programmable gate arrays (FPGAs) or application specific integrated circuits (ASICs), for example.

Among its other features, in accordance with example implementations, the wireless station 100 may include a radio 164, part of the physical layer 160, which communicates transmission and reception signals with the phased array antenna 110 through the transmission channels 144 and reception channels (not shown in FIG. 1). Moreover, the MAC layer 186 may include various other components other than the beamforming engine 188, such as a media access component 190, a resource management component 192, and so forth.

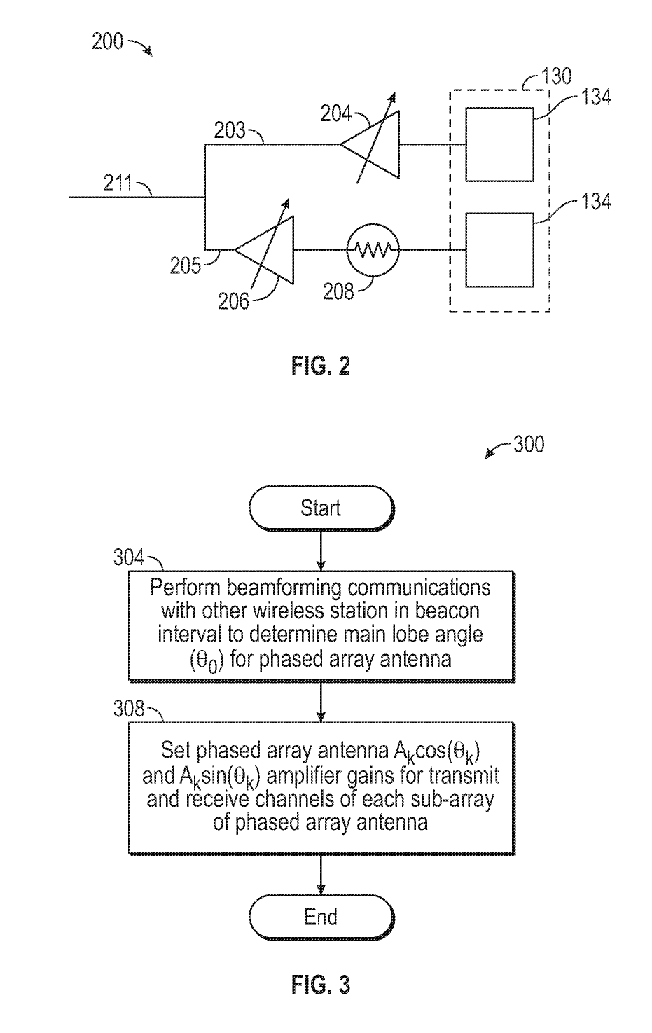

Although FIG. 1 depicts an example beamforming circuit 111 for purposes of configuring the phased array antenna 110 for a transmission antenna beam pattern, the systems and techniques that are described herein may also be used to form a reception antenna beam pattern for the phased array antenna 110. In this manner, referring to FIG. 2 in conjunction with FIG. 1, in accordance with example implementations, the beamforming circuit 111 may include a circuit 200 (FIG. 2) for each sub-array 130. The circuit 200 includes orthogonal signal channels 203 and 205 (i.e., communication paths or reception channels), which are coupled to a reception channel 211 and coupled to respective antenna elements 134 of the sub-array 130. As depicted in FIG. 2, for this example implementation, the signal channel 203 includes a low noise amplifier (LNA) 204 that has an input that is coupled to an associated antenna element 134 to receive a signal that is provided by the antenna element, and the LNA 204 has an output that is coupled to the reception channel 211 for purposes of providing an amplified, in-phase signal. The signal channel 205 communicates an orthogonal signal relative to the reception channel 211 due to a fixed ninety degree phase shifter 208 that is disposed in the reception channel 211. The signal channel 205 also includes an LNA 206 that has input that receives a signal from the associated antenna element 134 and an output that provides an amplified signal to the phase shifter 208.

Referring to FIG. 3 in conjunction with FIG. 1, in accordance with example implementations, the wireless station 100 may perform a technique 300, which includes the wireless station 100 performing (block 304) beamforming communications with another wireless station in a beacon interval to determine a main lobe angle θ₀ for the phased array antenna 110. The wireless station 100 may then set (block 308) the Aₖ cos(θₖ) and Aₖ sin(θₖ) amplifier gains for the transmission, or transmit, channels and reception, or receive, channels for each sub-array 130 of the phased array antenna 110 so that the wireless station 100 may use the phased array antenna 110 as configured for purposes of communicating data with the other wireless station in the data communication part of the beacon interval.

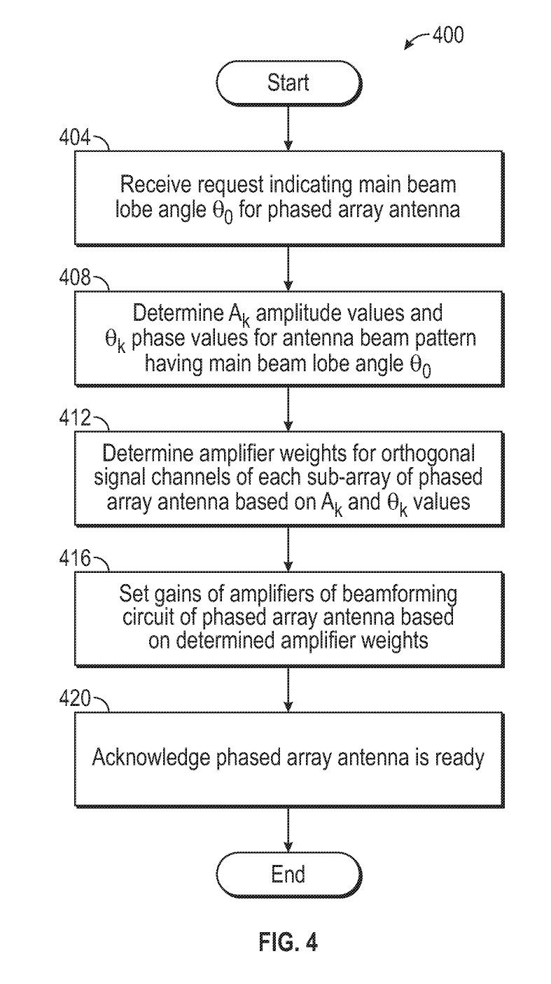

More specifically, referring to FIG. 4 in conjunction with FIG. 1, in accordance with example implementations, the controller 168 of the wireless station 100 may perform a technique 400 that includes receiving (block 404) a request indicating a main beam lobe θ₀ for the phased array antenna 110. The controller determines (block 408) the Aₖ amplitude values and θₖ phase values for an antenna beam pattern that has the main beam lobe θ₀. Depending on the particular embodiment, determining these values may involve calculating the values and/or looking up values from one or multiple tables that are stored in the memory 172. The controller 168 may then determine (block 412) amplifier weights for the orthogonal signal channels of sub-array of the phased array antenna based on the Aₖ amplitude values and θₖ phase values, by applying Eqs. 1 and 2 and/or looking up values from one or multiple tables; and then the controller 168 may set the gains of the amplifiers 140 and 142, pursuant to block 416.

In accordance with example implementations, although the gains of the amplifiers 140 and 142 may be based in part on the relationships that are set forth in Eqs. 1 and 2, the actual gains may be slightly different due to calibration adjustments. In this manner, in accordance with example implementations, the controller 168 may look up calibrated values for the amplifier gains from a table, the controller 168 may look up calibration factors to apply to calculated values for the gains, and so forth. After the gains of the amplifiers 140 and 142 are set, the controller 168 may then acknowledge to the MAC layer 186 that the phased array antenna has been configured, pursuant to block 420.

Referring to FIG. 5, in accordance with further example implementations, a wireless station 500 may be used instead of the wireless station 100 of FIG. 1. In general, the wireless station 500 may have a similar design to the wireless station 100, with the same reference numerals being used to denote components that are shared in common. For the wireless station 500, a phased array antenna 510 replaces the phased array antenna 110. The phased array antenna 510 is similar to the phased array antenna 110, and a beamforming circuit 511 of the antenna 510 is similar to the beamforming circuit 111 of the antenna 110. However, the controller 168 of the wireless station 500 calculates and applies the gains for the amplifiers 140 and 142 differently for purposes of reducing side lobe energy and for purposes causing the phased array antenna 510 to be less, if not completely, invariant to the intra sub-array spacing l (and correspondingly not requiring the inter sub-array spacing distance d to be much larger than the intra sub-array spacing distance l).

More specifically, in accordance with example implementations, the gains for the amplifiers 140 and 142 for the kth sub-array 130 may be described as follows:

Gain_{AMPLIFIER 140}=Aₖ cos(θₖ−ε), and Eq. 5

Gain_{AMPLIFIER 142}=Aₖ sin(θₖ+ε). Eq. 6

The phase offset ε of Eqs. 5 and 6 may be described as follows:

$$ɛ = \frac{π l sin {θ}_{0}}{λ} . \qquad Eq . 7$$

It is noted that Eqs. 5 and 6 depict the general relationship of the amplifier gains to the phase value θₖ and the phase offset ε; and if for the case in which l<<d, the phase offset ε can be ignored, and Eqs. 5 and 6 may be simplified to Eqs. 1 and 2, respectively. Using the gains for the amplifiers 140 and 142 as described in Eqs. 5 and 6, the P(θ₀) antenna gain may be described as follows:

$$P ( {θ}_{0} ) = {‖ {\sum }_{k = 1}^{N} {A}_{k} {e}^{\frac{j2 π d ( k - 1 ) sin ( θ )}{λ}} \{ cos ( {θ}_{k} - ɛ ) {e}^{j ɛ} - j sin ( {θ}_{k} + ɛ ) {e}^{- j ɛ} \} ‖}^{2} . \qquad Eq . 8$$

A particular advantage of phased array antenna 510 of FIG. 5 is that the side lobe energy of the antenna gain (as compared to the main lobe energy) is reduced, as compared to the antenna gain for the phased array antenna 110 of FIG. 1. Moreover, in accordance with example implementations, the antenna gain for the phased array antenna 510 is independent of the intra sub-array spacing l.

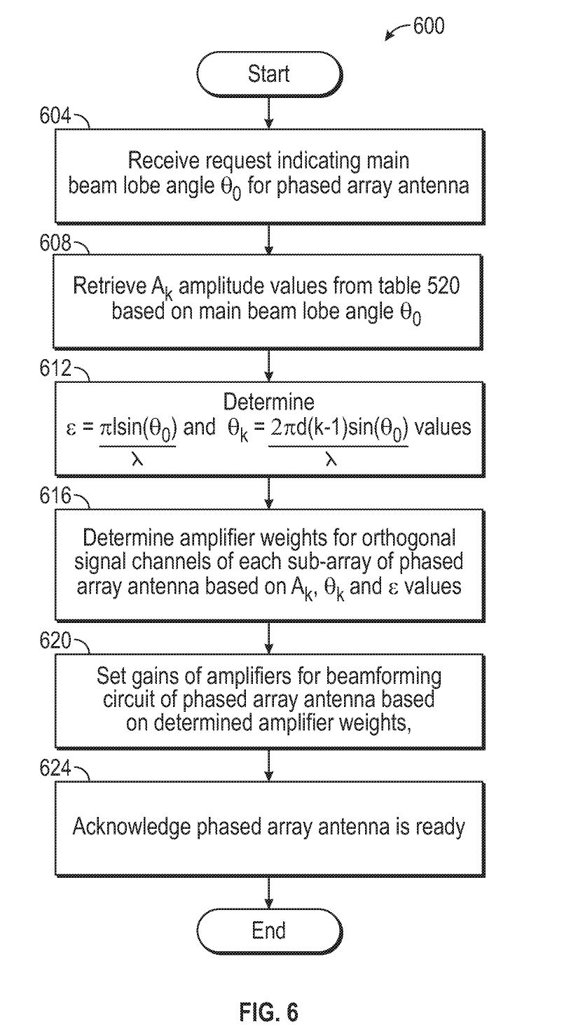

Referring to FIG. 6 in conjunction with FIG. 5, in accordance with example implementations, the controller 168 of the wireless station 500 may perform a technique 600 that is depicted in FIG. 6. Pursuant to the technique 600, the controller 168 receives (block 604) data representing, or indicating, the main beam lobe θ₀. The controller 168 then retrieves (block 608) Aₖ amplitude values from a table 520 (of the memory 172) based on the main beam lobe θ₀. Alternatively, in accordance with further example implementations, the controller 168 may calculate the Aₖ amplitude values.

The controller 168 may then determine (block 612) the ε and θₖ values using Eqs. 7 and 3, respectively. Based on the Aₖ, θₖ and ε values, the controller 168 may then determine (block 616) amplifier weights for the amplifiers 140 and 142 (pursuant to Eqs. 5 and 6) and set the gains of the amplifiers 140 and 142, pursuant to block 620. In accordance with example implementations, determining the amplifier gains may involve the controller 168 looking up calibrated gains from a table and/or applying calibration correction factors. Lastly, after setting the amplifier gains, the controller 168 may acknowledge to the MAC layer 186 that the phase array antenna 510 has been configured, pursuant to block 624.

While the present disclosure has been described with respect to a limited number of embodiments, those skilled in the art, having the benefit of this disclosure, will appreciate numerous modifications and variations therefrom. It is intended that the appended claims cover all such modifications and variations.

What is claimed is:

1. A method comprising:
communicating orthogonal signals with an antenna array, wherein the antenna array comprises a plurality of pairs of antenna elements;
amplifying the orthogonal signals; and
controlling the amplifying of the orthogonal signals to regulate a directivity of a beam pattern of the antenna array.

2. The method of claim 1, wherein communicating orthogonal signals further comprises:
communicating a first signal of the orthogonal signals using a first communication path comprising a fixed phase shifter and a first amplifier; and
communicating the second signal of the orthogonal signals using a second communication path comprising a second amplifier.

3. The method of claim 2, wherein:
communicating the first signal comprises receiving the first signal from a first antenna element of a given pair of antenna elements and providing the first signal to the first communication path; and
communicating the second signal comprises receiving the second signal from a second antenna element of the given pair of antenna elements and providing the second signal to the second communication path.

4. The method of claim 2, wherein:
communicating the first signal comprises receiving the first signal from the first communication path and providing the first signal to a first antenna element of a given pair of antenna elements; and
communicating the second signal comprises receiving the second signal from the second communication path and providing the second signal to a second antenna element of the given pair of antenna elements.

5. The method of claim 2, wherein:
communicating the first signal using the first communication path comprises setting a gain of the first amplifier based on the cosine of a phase angle; and
communicating the second signal using the second communication path comprises setting a gain of the second amplifier based on the sine of the phase angle.

6. The method of claim 2, wherein:
communicating the first signal using the first communication path comprises setting a gain of the first amplifier based on the product of an amplitude and cos(θₖ−ε); and
communicating the second signal using the second communication path comprises setting a gain of the second amplifier based on the product of the amplitude and sin(θₖ+ε).

7. The method of claim 6, wherein:
the antenna elements of a given pair of antenna elements are associated with a spacing l between the elements of the given pair;
a main lobe of the beam pattern is associated with an angle θ₀;
the first and second signals are associated with a wavelength λ; and
ϵ represents π·|·sin(θ₀)/λ.

8. The method of claim 6, wherein:
adjacent pairs of the pairs of antenna elements are separated by a spacing d; and
θₖ represents 2π·(k−1)·d·sin(θ₀)/λ, where θ₀ represents a main lobe of the beam pattern, λ represents a wavelength associated with the first and second signals, and k represents an integer.

9. The method of claim 1, wherein the beam pattern comprises a reception beam pattern or a transmission beam pattern.

10. An apparatus comprising:
a planar array of antenna elements, wherein the antenna elements are grouped into a plurality of sub-arrays;
a beamforming circuit comprising a plurality of amplifiers, the beamforming circuit to, for each sub-array of the plurality of sub-arrays, communicate a first signal with a first antenna element of the sub-array and communicate a second signal with a second antenna element of the sub-array, wherein the first and second signals are orthogonal relative to each other; and
a controller to regulate the gains of the plurality of amplifiers to regulate a directivity of a beam pattern associated with the array.

11. The apparatus of claim 10, wherein the plurality of amplifiers comprises power amplifiers.

12. The apparatus of claim 10, wherein the plurality of amplifiers comprises low noise amplifiers.

13. The apparatus of claim 10, wherein:
each sub-array of the plurality of sub-arrays is associated with a phase value of a plurality of phase values;
wherein the plurality of amplifiers comprise a first amplifier and a second amplifier;
the first amplifier has a first gain;
the second amplifier has a second gain; and
the controller to set the first and second gains of the first and second amplifiers such that a ratio of the first gain to the second gain is the cosine of the associated phase value divided by the sine of the associated phase value.

14. The apparatus of claim 13, wherein:
each sub-array of the plurality of sub-arrays is further associated with an amplitude value of a plurality of amplitude values; and
the first gain of the first amplifier comprises the product of the associated amplitude value and the cosine of the associated phase value, and the second gain of the second amplifier comprises the product of the associated amplitude value and the sine of the associated phase value.

15. The apparatus of claim 10, wherein the beamforming circuit further comprises, for each sub-array of the plurality of sub-arrays:
an associated fixed phase shifter.

16. The apparatus of claim 15, wherein the fixed phase shifter comprises a ninety degrees fixed phase shifter.

17. An apparatus comprising:
a radio;
a phased array antenna coupled to the radio to radiate electromagnetic energy and sense radiated electromagnetic energy, the phased array antenna comprising:
a planar array of antenna elements arranged in pairs, wherein each pair of antenna elements is associated with an amplitude value and a phase value associated with an antenna beam pattern;
a beamforming circuit comprising, for a given pair of antenna elements of the antenna elements:
a first communication path to communicate a first signal with a first element of the given pair of antenna elements, the first communication path comprising a first amplifier;
a second communication path to communicate a second signal with a second element of the given pair of antenna elements, the second communication path comprising a second amplifier; and
at least one fixed phase shifter disposed in one of the first and second communication paths to cause the first and second signals to be orthogonal to each other; and
a controller to, for the given pair of antenna elements, set a first gain of the first amplifier and set a second gain of the second amplifier to regulate a directivity of the antenna beam pattern.

18. The apparatus of claim 17, wherein:
the ratio of the first gain to the second gain is cos(θₖ−ϵ)/sin(θₖ+ϵ);
the antenna elements of the given pair are separated by a distance l;
a main lobe of the beam pattern has an associated angle θ₀; and
ϵ represents π·|·sin(θ₀)/λ, where λ represents a wavelength associated with the first and second signals.

19. The apparatus of claim 17, wherein:
wherein the ratio of the first gain to the second gain is cos(θₖ−ϵ)/sin(θₖ+ϵ);
adjacent pairs are separated by a spacing d; and
θₖ represents 2π(k−1)d sin(θ₀)/λ, where θ₀ represents a main lobe of the beam pattern, λ represents a wavelength associated with the signals, and k represents an integer.

20. The apparatus of claim 17, wherein the antenna beam pattern comprises a transmission beam pattern or a reception beam pattern.

21. The apparatus of claim 17, further comprising:
a beamforming engine to communicate with a wireless station using the phased antenna array in a first part of a beacon interval to determine a main lobe of the antenna beam pattern to be used in a second part of the beacon interval.

22. The apparatus of claim 17, wherein the at least one fixed phase shifter comprises a fixed ninety degree phase shifter.

23. The apparatus of claim 17, wherein the phased array antenna comprises a continuous phased array antenna or a digital phased array antenna.
